(19) United States
(12) Patent Application Publication
(10) Pub. No.: US 2014/0070640 A1
(43) Pub. Date: Mar. 13, 2014

(54) COOLING DUCTS IN AN ELECTRO-DYNAMIC MACHINE

(71) Applicants: Anil Kumar Tolpadi, Niskayuna, NY (US); Srinath Varadarajan Ekkad, Blacksburg, VA (US); Christopher Anthony Kaminski, Niskayuna, NY (US); Samir Armando Salamah, West Chester, OH (US)

(72) Inventors: Anil Kumar Tolpadi, Niskayuna, NY (US); Srinath Varadarajan Ekkad, Blacksburg, VA (US); Christopher Anthony Kaminski, Niskayuna, NY (US); Samir Armando Salamah, West Chester, OH (US)

(73) Assignee: GENERAL ELECTRIC COMPANY, Schenectady, NY (US)

(21) Appl. No.: 13/613,187

(22) Filed: Sep. 13, 2012

(51) Int. Cl. H02K 1/20

(52) U.S. Cl. 310/59

(57) ABSTRACT

A generator stator core assembly is disclosed. The assembly includes a plurality of packages of stacked laminations, each package including an outermost lamination having a plurality of radially extending spacer blocks. The plurality of radially extending spacer blocks and adjacent axially spaced laminations define a radial cooling duct, and the outermost lamination includes a plurality of recesses such that a flow through the cooling duct flows over the plurality of recesses. In one embodiment, at least one adjacent axially spaced lamination defining the radial cooling duct also includes a plurality of recesses.

### FIELD OF THE INVENTION

The subject matter disclosed herein relates to electro-dynamic machines, such as generators. More particularly, aspects of the disclosure relate to cooling ducts in an electro-dynamic machine for enhanced generator stator cooling duct performance.

### BACKGROUND OF THE INVENTION

A generator stator core is made up of a series of magnetic layers, or “laminations” stacked together. Along an axial length of the layers, a thicker lamination can be placed, with an I-beam welded on it, which creates a coolant passage. This thicker lamination can be referred to as an Inside Space Block (ISSB) lamination. This coolant passage e or duct can be referred to as a “ventilation duct”, disposed between the magnetic laminations of the generator stator core, which allows coolant to flow through the duct. The stator core becomes hot during operation of the generator and the heat must be removed to keep it from overheating. Heat is also generated in stator bars placed within teeth cut-outs in the laminations. Cooling the generator stator core, and managing the heat transfer in the stator duct, is important for reliable generator performance.

Attempts to improve thermal performance in a generator stator core have included changing the shape and orientation of the coolant passages, adding cooling tubes in the stator, or altering the coolant flow through the ducts by including protrusions into the flow duct to disrupt the flow.

### BRIEF DESCRIPTION OF THE INVENTION

An improved generator stator core assembly is disclosed for enhancing cooling duct performance by having coolant flow over a plurality of recesses on the surface. The assembly includes a plurality of packages of stacked laminations, each package including an outermost lamination having a plurality of radially extending spacer blocks. The plurality of radially extending spacer blocks and adjacent axially spaced laminations define a radial cooling duct, and the outermost lamination includes a plurality of recesses such that a flow through the cooling duct flows over the plurality of recesses. In one embodiment, at least one adjacent axially spaced lamination defining the radial cooling duct also includes a plurality of recesses.

A first aspect of the invention includes a generator stator core assembly comprising: a plurality of packages of stacked laminations, each package including an outermost lamination having a plurality of radially extending spacer blocks, wherein the plurality of radially extending spacer blocks and adjacent axially spaced laminations define a radial cooling duct, and wherein the outermost lamination includes a plurality of recesses such that a flow of coolant through the cooling duct flows over the plurality of recesses.

A second aspect of the invention includes a generator comprising: a rotor; and a stator including a laminated core section, the laminated core section comprising: a plurality of packages of stacked laminations, each package including an outermost lamination having a plurality of radially extending spacer blocks, wherein the plurality of radially extending spacer blocks and adjacent axially spaced laminations define a radial cooling duct, and wherein the outermost lamination includes a plurality of recesses such that a flow of coolant through the cooling duct flows over the plurality of recesses.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an enlarged cut-away view of a portion of a conventional stator core lamination assembly;

FIG. 2 shows an elevation view of a conventional generator stator lamination and inside spacer blocks;

FIG. 3 shows a sectional view of a conventional inside spacer block taken along line 2-2;

FIG. 4 shows an enlarged cut-away view of a portion of a stator core lamination assembly according to an embodiment of the invention;

FIG. 5 shows an elevation view of a front side of a generator stator lamination and inside spacer blocks according to an embodiment of the invention;

FIG. 6 shows an elevation view of a back side of a generator stator lamination according to an embodiment of the invention;

FIGS. 7 and 8 show elevation views of a generator stator lamination according to embodiments of the invention;

FIG. 9 shows an isometric view of a generator stator lamination according to another embodiment of the invention;

FIG. 10 shows an isometric view of two axially spaced adjacent laminations according to an embodiment of the invention; and

FIGS. 11 and 12 show sectional views of axially spaced adjacent laminations taken along line 11-11 according to embodiments of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

Structures for improving generator stator duct performance using recesses in a lamination defining a coolant duct are disclosed. As discussed herein, recesses (also referred to as dimples, holes, concavities, indentions, trenches, or depressions) are introduced in the flow path of a coolant duct to enhance heat transfer while minimizing the pressure drop penalty typically incurred in the duct.

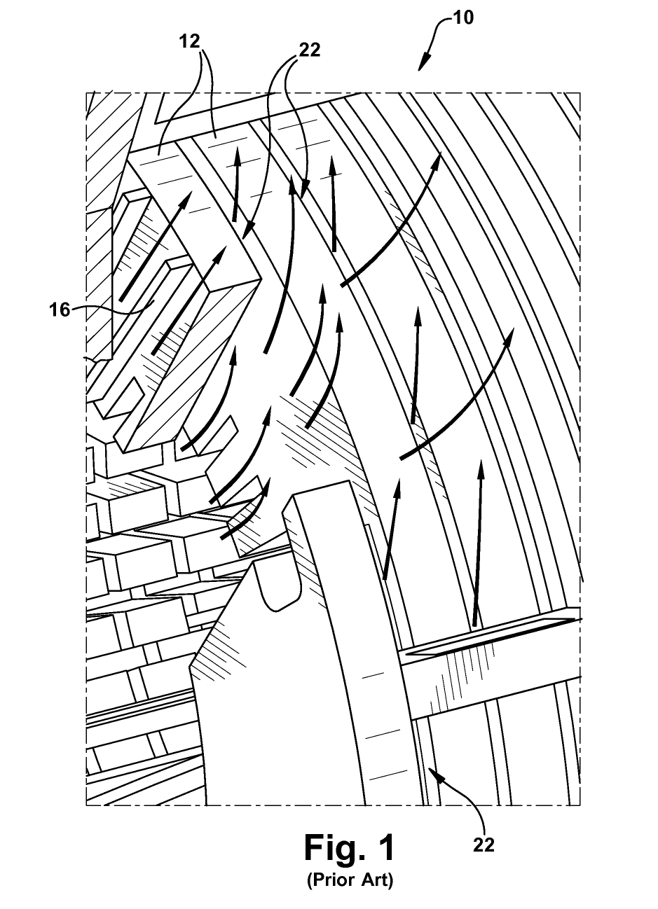

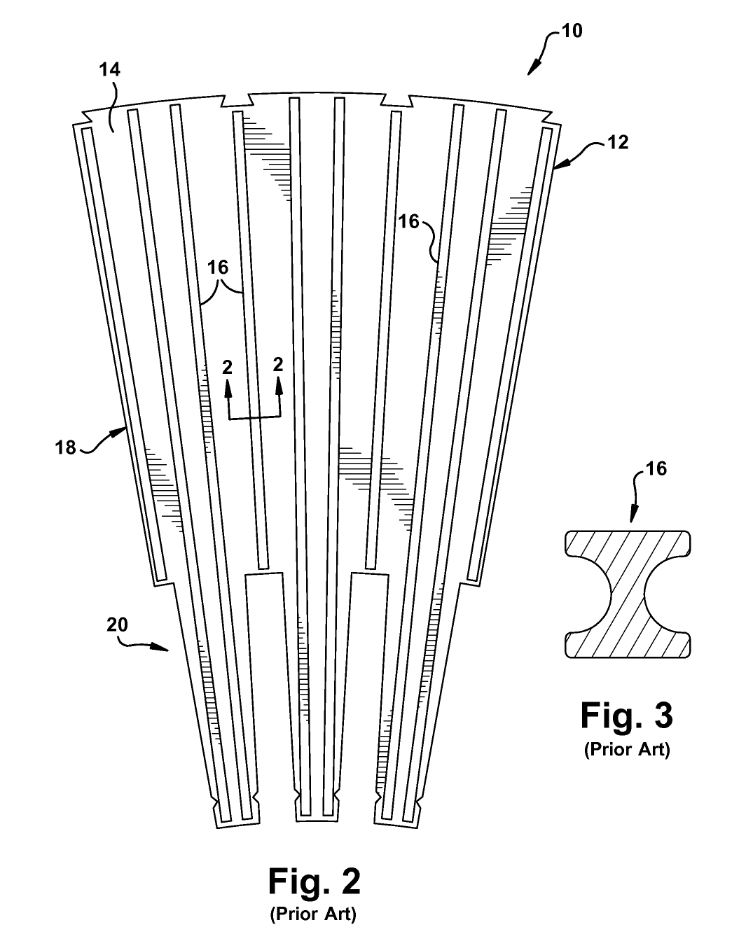

Turning to FIG. 1, a portion of a conventional stator core lamination assembly 10 within a stator of a generator is shown. As known in the art, assembly 10 includes a plurality of lamination stacks 12, or “packages”. Lamination packages 12 each include a plurality of metallic, magnetic, laminations 14 (FIG. 2) stacked on top of each other. Except as noted below, these laminations 14 (FIG. 2) are typically approximately 0.014 to 0.018 inch thick, and each package 12 is approximately 1 to 3 inches thick.

As shown in FIGS. 1 and 2, a plurality of inside spacer blocks or rods 16 are secured to an “outermost” lamination 14 of package 12. Shorter spacer blocks or rods 16 extend radially along a yoke portion 18 of the core lamination, and longer spacer blocks or rods 16 extend radially along the yoke region 18 and also along the radially inner tooth region 20. The lamination 14 to which inside spacer blocks 16 are welded is thicker than the remaining laminations in the package, for example, approximately 0.025 inch thick. This thicker lamination can be referred to as an Inside Space Block (ISSB) lamination. It is understood that ranges of thickness are provided as examples only and any desired thicknesses can be used.

In one embodiment, inside spacer blocks 16 have a generally I-beam shape in cross section (see FIG. 3), with the flat sides engaging adjacent stator core lamination packages 12. Although an I-beam shape is discussed herein, it is understood that any shaped spacer block 16 can be used. The radially extending spacer blocks 16 and adjacent axially spaced laminations 14 define a plurality of radially extending coolant passages or ducts 22, as shown in FIG. 1. Coolant flow through ducts 22 is illustrated with the arrows in FIG. 1. Depending on the particular cooling arrangement, coolant flow may be in a radially inward or radially outward direction. Typically, inside spacer blocks 16 have a height of approximately 0.250 inches, which also then defines the height of coolant duct 22. The width of spacer blocks 16 can also be approximately 0.250 inches. It is understood that ranges of heights are provided as examples only and any desired heights can be used.

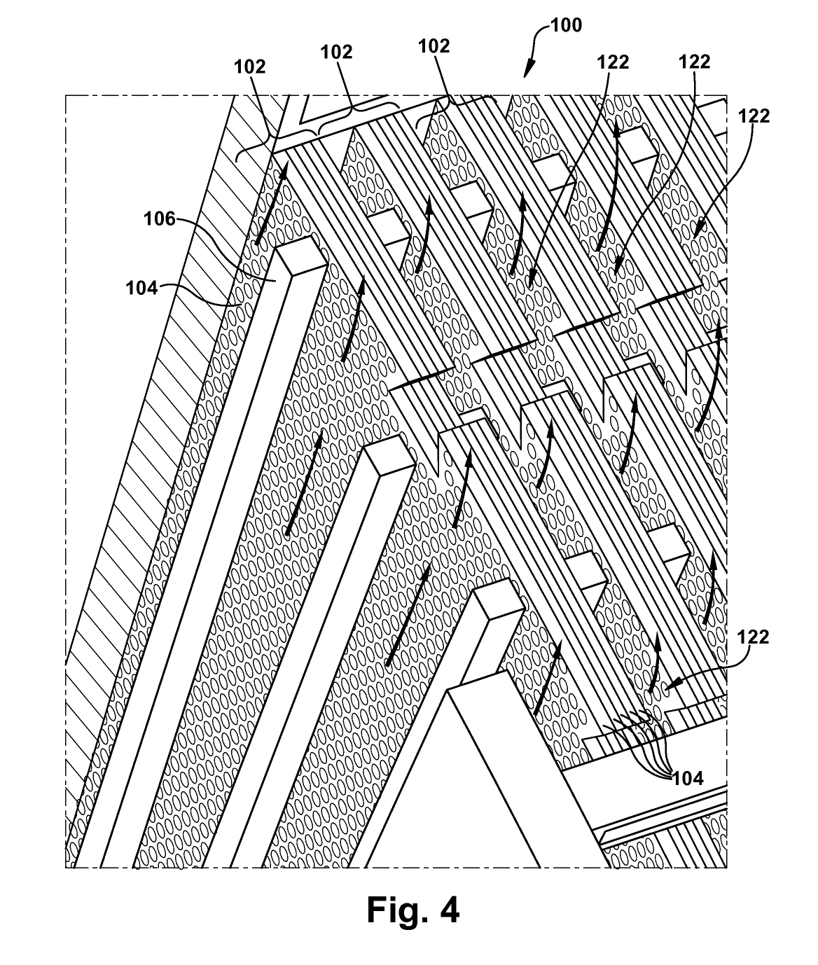

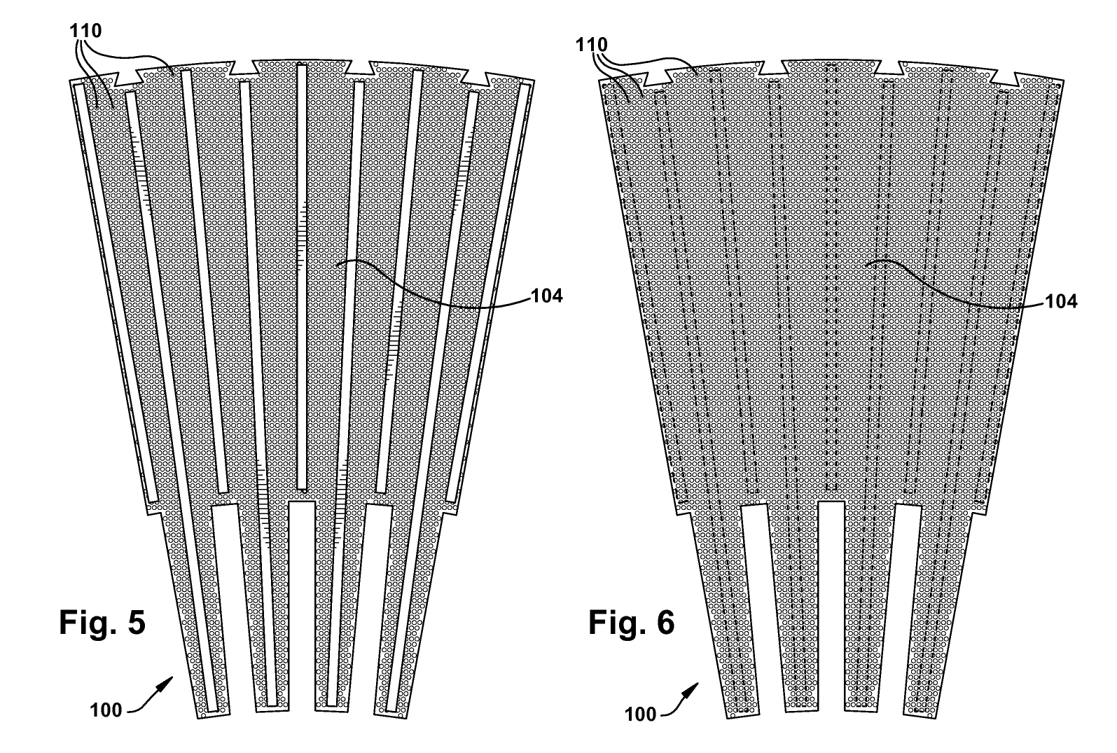

Turning now to FIG. 4, a first embodiment of the invention is illustrated. The stator core lamination assembly 100 is generally similar to that shown in FIG. 1 in that radially oriented coolant ducts 120 are formed by radially extending spacer blocks 106 and two axially spaced adjacent laminations 104 of adjacent lamination packages 102. Coolant flow through ducts 120 are illustrated with the arrows in FIG. 5. However, as shown in more detail in FIG. 5, in contrast to conventional assemblies, ducts 120 are non-uniform, i.e., assembly 100 includes a plurality of recesses 110 (or dimples, holes, concavities, indentions, trenches, or depressions as discussed herein) in the outermost laminations 104, such that flow through coolant ducts 120 flows over the plurality of recesses 110.

Recesses 110 have the effect of increasing the surface area across lamination 104 over which the coolant flows, and therefore, increasing the surface area of duct 120. In addition, recesses 110 have the effect of enhancing coolant mixing as the flow moves across the uneven surface of lamination 104. These effects will augment heat transfer and improve overall thermal performance of assembly 100. In contrast to prior art methods that rely on putting protrusions into the coolant flow, recesses 110 of the claimed invention do not protrude into the flow, but instead allow the flow to flow over the recesses 110. When flow moves over a recesses 110, it will separate, which breaks up the flow. In prior art systems that include protrusions, the pressure drop across the system is higher as the flow needs more pressure to move past the protrusions. In contrast, embodiments of this invention require a lower pressure drop to move the flow than designs that include protrusions into the flow. At the same time, embodiments of the invention include an increased surface area of duct 120 as compared to a duct without recesses 110.

In one embodiment, shown in FIGS. 5 and 6, a perforated sheet is used to form lamination 104, such that recesses 110 comprise a series of holes 110 across the entire lamination 104. FIG. 5 shows a top view of lamination 104 including holes 110 and spacer blocks 106, while FIG. 6 shows a bottom view of lamination 104. (Also visible in the bottom view in FIG. 6 are weld marks where each I-beam is welded to the lamination).

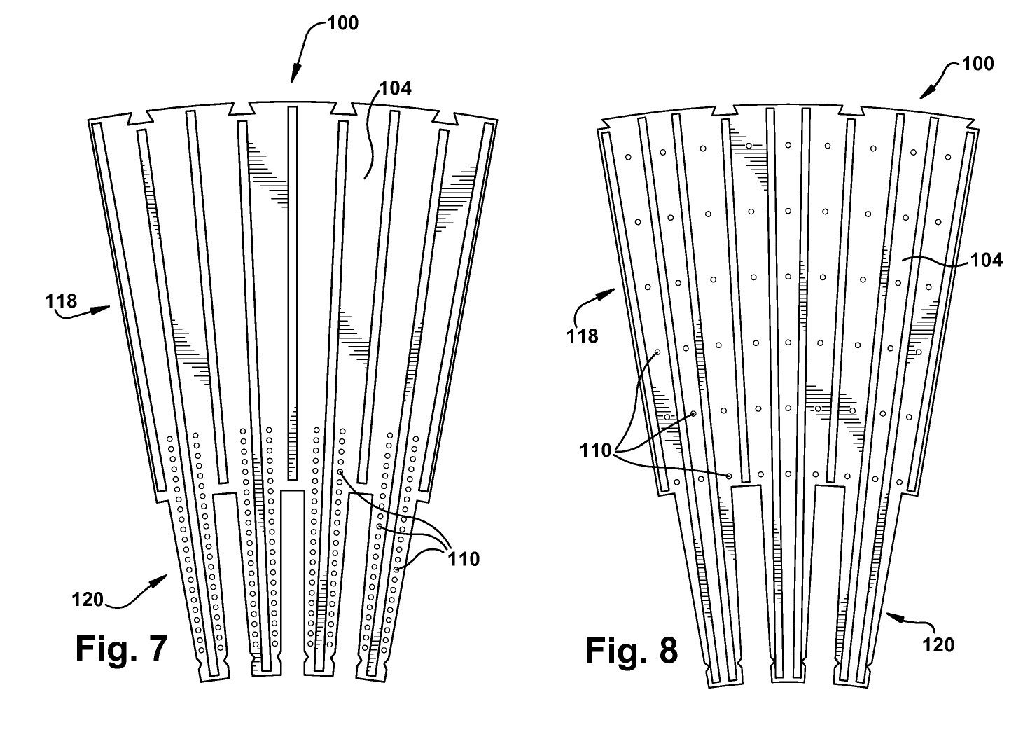

It is understood that any pattern of recesses or holes 110 can be used, for example, as shown in FIG. 7, recesses 110 can be included primarily in a radially inner tooth region 120, and not throughout a yoke region 118. In another example, shown in FIG. 8, recesses 110 can be included primarily in the yoke region 118, and not as much in the tooth region 120. In any embodiment, an irregular or staggered pattern of recesses 110 can be used, or a uniform, or regular, pattern of evenly spaced apart recesses 110 can be used. In other examples, recesses 110 can be positioned in inner tooth region 120 and yoke region 118 such that they form a uniformly spaced locus that follows the edges of lamination 104, a double row of offset recesses 110 that follow the edges of lamination 104 and spacer blocks 106, and/or a uniform array of clustered groupings of recesses 110, and/or a random distribution of recesses 110 with a range of minimum and maximum bounds.

In addition, recesses 110 can be any size desired. In one example, recesses 110 can have a diameter of approximately 0.125 inches. Recesses 110 can be spaced apart as much as desired. In one embodiment, spacing between recesses 110 is approximately 1.5 times a diameter of a recess 110.

While cylindrical recesses 110 in the shape of holes 110 are shown in FIGS. 4-8, it is understood that any shaped recesses can be used. For example, recesses or holes with any of the following cross-sectional shapes can be used: circular, square, rectangular, oval, diamond, triangular, trapezoidal, hexagonal, octagonal, pentagonal, star, or an irregularly shaped polygon. In other examples, recesses 110 can be any n-sided polygon with internal angles that can be acute (less than approximately 90 degrees), obtuse (greater than approximately 90 degrees but less than approximately 180 degrees) or reflex (greater than approximately 180 degrees). In addition, rounded polygons, i.e., rounded versions of any n-sided polygon, and/or quasi-polygons, i.e., any n-sided polygon with substantially straight edges that comprise a series of splines, can be used, with acute, obtuse, or reflex angles. For example, dimples formed by an irregular n-sided polygon (with some combination of either sharp or rounded corners) at the surfaces, which either (1) have a uniform section (i.e., cylindrical volume) through the depth of the dimple, or alternatively, (2) have a uniform reduction in size with increasing depth (i.e. a conical volume) which comes to a point at the maximum depth of the dimple, or alternatively, (3), have a nominally graduated reduction in size with increasing depth, thereby forming a substantially hemispherical volume, while preserving the general shape of the irregular n-sided polygon, substantially self-similar in shape, but at a different scale at each depth from the surface. As such, recesses 110 can comprise any shape made from straight sided walls, rounded walls, and/or partially rounded and partially straight walls.

All the recesses 110 across lamination 104 can have a similar shape and size, or recesses 110 can have varying shapes and sizes as desired. In addition, recesses 110 can have a geometry or shape that varies along a depth of the hole or recess, or recesses 110 can comprise any shaped hole or recess that has a varying diameter along its depth. For example, if the surface shape is circular, then recess 110 could be substantially hemispherical or substantially conical, or if the surface shape was star shaped or polygon shaped, recess 110 could also exhibit a linear variation with depth (thereby being substantially conical or spherical), with each slice below the surface being a smaller version of its shape at the surface.

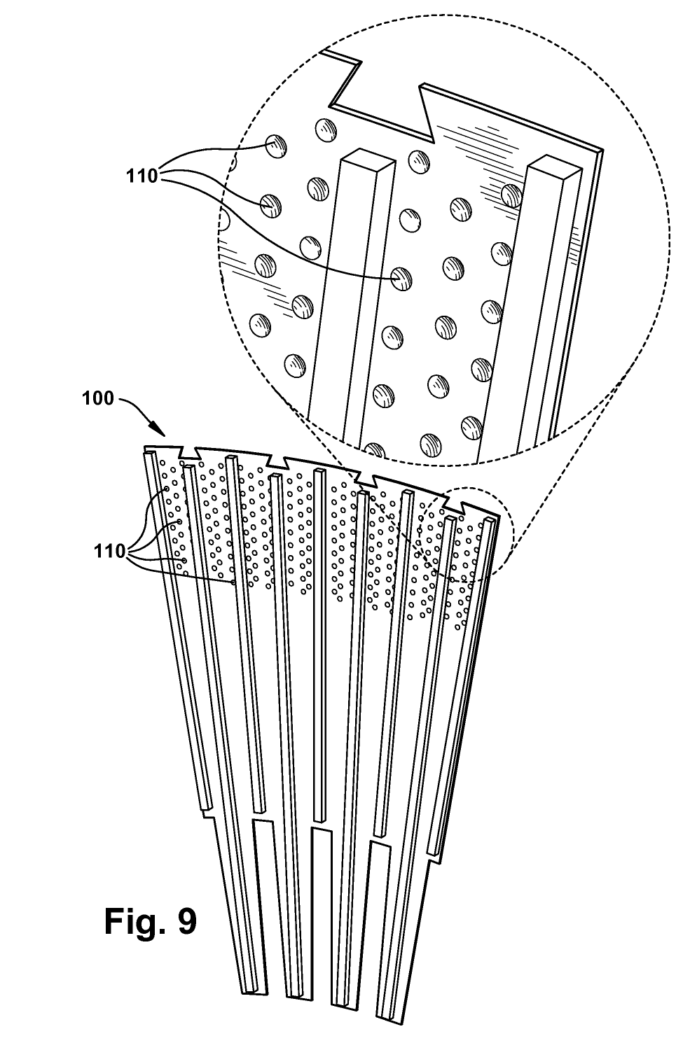

It is understood that recesses 110 refer to any hole or cavity that extends into a lamination 104, rather than protruding into duct 120. As shown in FIGS. 4-9, recesses 110 are positioned such that recesses 110 are exposed to coolant flow through duct 120. Recesses 110 can comprise holes that extend completely through lamination 104, or recesses or cavities that only partially extend into lamination 104. For example, dimples, holes, concavities, indentions, trenches, depressions, or other partial holes. In one example of a recess 110 that extends only partially into lamination 104, shown in FIG. 9, a hemispherical dimple is used, that only partially extends into lamination 104. It is also understood that each lamination 104 can include both recesses 110 that extend entirely through lamination 104 as well as recesses 110 that only partially extend into lamination 104.

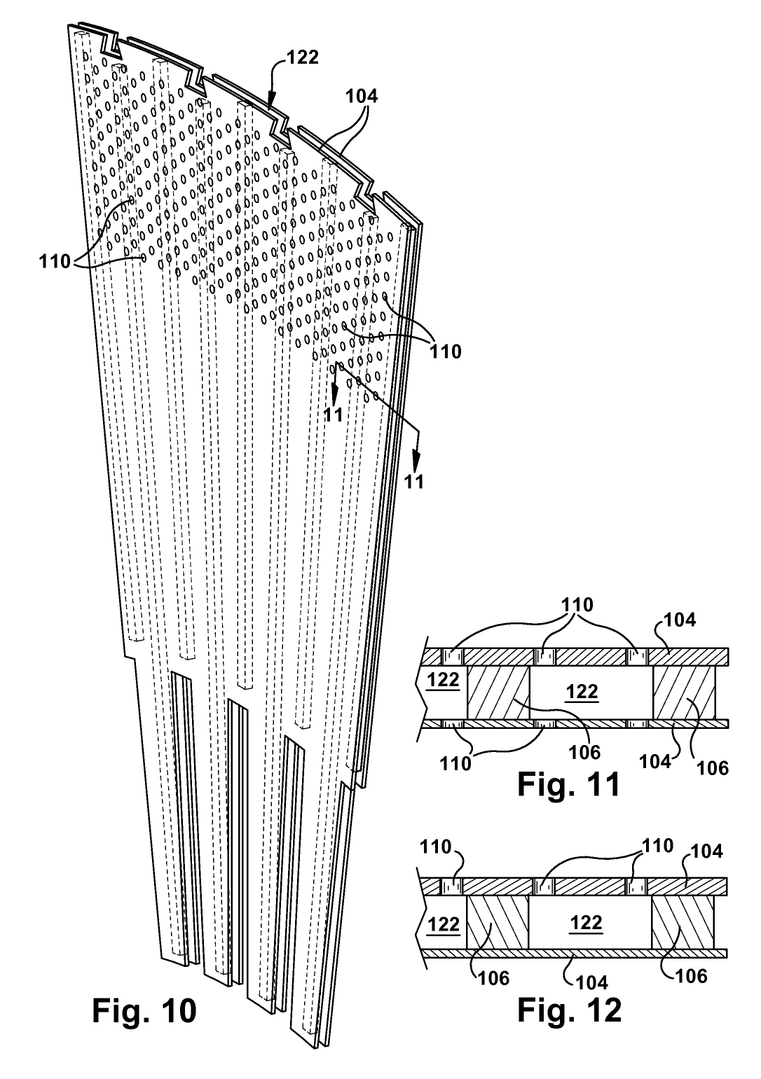

It is also understood that while recesses 110 are discussed herein as being included in the ISSB thicker lamination 104 in package 102, either, or both, axially spaced lamination 104 forming duct 120 can include recesses 110. FIG. 10 shows two axially spaced adjacent laminations 104, with duct 120 therebetween. In one configuration, shown in FIG. 11, the thicker ISSB lamination 104 (including the spacer blocks 106) includes recesses 110, and the opposite lamination 104 would be a thinner, core lamination without recesses 110. In another configuration, as shown in FIG. 12, both the ISSB thicker lamination 104 (including the spacer blocks 106) and the opposite core lamination 104 would have recesses 110. In this embodiment shown in FIG. 12, coolant flow through duct 120 will flow over both the plurality of recesses 110 in the ISSB thicker lamination 104 as well as the plurality of recesses 110 in the axially spaced adjacent core lamination 104.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It is further understood that the terms “front” and “back” are not intended to be limiting and are intended to be interchangeable where appropriate.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A generator stator core assembly comprising:
a plurality of packages of stacked laminations, each package including an outermost lamination having a plurality of radially extending spacer blocks, wherein the plurality of radially extending spacer blocks and adjacent axially spaced laminations define a radial cooling duct, and wherein the outermost lamination includes a plurality of recesses such that a flow of coolant through the cooling duct flows over the plurality of recesses.

2. The generator stator core assembly of claim 1, wherein the plurality of recesses extend completely through the outermost lamination.

3. The generator stator core assembly of claim 1, wherein the plurality of recesses extend only partially into the outermost lamination.

4. The generator stator core assembly of claim 1, wherein the plurality of recesses comprise one of: a regular pattern of recesses and an irregularly pattern of recesses.

5. The generator stator core assembly of claim 1, wherein the plurality of recesses comprise one of: regularly shaped recesses, and irregularly shaped recesses.

6. The generator stator core assembly of claim 1, wherein the plurality of recesses are positioned primarily in a radially outward yoke area of the outermost lamination.

7. The generator stator core assembly of claim 1, wherein the plurality of recesses are positioned primarily in a radially inward tooth area of the outermost lamination.

8. The generator stator core assembly of claim 1, wherein an interval space between a particular recess and an adjacent recess is approximately 1.5 times a diameter of the particular recess.

9. The generator stator core assembly of claim 1, wherein the plurality of recesses each have one of the following cross-sectional shapes: cylindrical, square, rectangular, oval, diamond, triangular, trapezoidal, hexagonal, octagonal, pentagonal, or star.

10. The generator stator core assembly of claim 1, wherein the plurality of recesses comprise at least one of: an n-sided polygon having straight sides, an n-sided rounded polygon having at least partially rounded sides, and a quasi-polygon having substantially straight edges.

11. The generator stator core assembly of claim 1, wherein at least one adjacent axially spaced lamination also includes a plurality of recesses, such that the flow through the cooling duct flows over both the plurality of recesses in the outermost lamination and the plurality of recesses in the at least one adjacent axially spaced lamination.

12. The generator stator core assembly of claim 1, wherein at least one of the plurality of recesses has a varying diameter along a depth of the recess.

13. The generator stator core assembly of claim 1, wherein the plurality of recesses are positioned such that a pattern of recesses comprise at least one of the following: a uniformly spaced locus that follows edges of the outermost lamination, a double row of offset recesses that follows the edges of the outermost lamination and the spacer blocks, a uniform array of clustered groupings of recesses, and a random distribution of recesses with a range of minimum and maximum bounds across the outermost lamination.

14. The generator stator core assembly of claim 1, wherein the plurality of recesses are regularly or irregularly spaced, and the plurality of recesses penetrate the surface to form recesses with volumes that are substantially conical, cylindrical, or hemispherical.

15. A generator comprising:
a rotor; and
a stator including a laminated core section, the laminated core section comprising:
a plurality of packages of stacked laminations, each package including an outermost lamination having a plurality of radially extending spacer blocks, wherein the plurality of radially extending spacer blocks and adjacent axially spaced laminations define a radial cooling duct, and wherein the outermost lamination includes a plurality of recesses such that a flow of coolant through the cooling duct flows over the plurality of recesses, wherein the plurality of recesses comprise one of: regularly shaped recesses, and irregularly shaped recesses.

16. The generator of claim 15, wherein the plurality of recesses extend completely through the outermost lamination or extend only partially into the outermost lamination.

17. The generator of claim 15, wherein the plurality of recesses comprise at least one of: an n-sided polygon having straight sides, an n-sided rounded polygon having at least partially rounded sides, and a quasi-polygon having substantially straight edges.

18. The generator of claim 15, wherein the plurality of recesses penetrate the surface to form recesses with volumes that are substantially conical, cylindrical, or hemispherical.

19. The generator of claim 15, wherein at least one adjacent axially spaced lamination also includes a plurality of recesses, such that the flow through the cooling duct flows over both the plurality of recesses in the outermost lamination and the plurality of recesses in the at least one adjacent axially spaced lamination.

20. The generator of claim 15, wherein the plurality of recesses are positioned such that a pattern of recesses comprise at least one of the following: a uniformly spaced locus that follows edges of the outermost lamination, a double row of offset recesses that follows the edges of the outermost lamination and the spacer blocks, a uniform array of clustered groupings of recesses, and a random distribution of recesses with a range of minimum and maximum bounds across the outermost lamination.
